(19) United States
(12) Patent Application Publication
(10) Pub. No.: US 2023/0310270 A1
(43) Pub. Date: Oct. 5, 2023

(54) Vial

(71) Applicant: David Lee Carter, Vance, AL (US)

(72) Inventor: David Lee Carter, Vance, AL (US)

(21) Appl. No.: 18/195,478

(22) Filed: May 10, 2023

Related U.S. Application Data
(63) Continuation-in-part of application No. 17/246,731, filed on May 3, 2021.

(51) Int. Cl. A61J 1/14

(52) U.S. Cl. CPC A61J 1/14

(57) ABSTRACT

A vial container is disclosed to have a base, body, and top portion. The body portion is structured to have at least three flat sides with at least one indented textured grip and an optional neck or collar to attach lids or caps.

### BACKGROUND

The commonly used body structure of medicinal vials is a cylinder or round shape, which decreases the inner volume space for storage of medicinal elements in the vial. The common body shape also limits the number of vial containers that can be stored in a given space for shipping, refrigeration, or shelf storage. When common vials are in use, the total extraction of medicinal elements isn't efficient due to the round shape. This contributes to waste, and reduces the total quantity of doses that may have otherwise been administered. The smooth cylinder shape of common vials do not have at tactile textured surface area for gripping for safer use reducing needle sticks.

### BRIEF SUMMARY

In summary, the structural shape of the embodiment increases the volume of unit doses of the medicinal element stored within the container. The external structure increases the number of vial containers that can be stored or stacked in storage space e.g., shipping or refrigeration space. The textured grip provides safer use and the embodiment inner cavity structure provides a more efficient method of extraction of final unit doses reducing waste.

### DETAILED DESCRIPTION

The embodiment described herein is directed toward the vial container structure and shape. The embodiment includes an open top portion 5 with an optional neck or collar 10 for attaching a cap or lid, a body portion 15 with at least three flat sides 20, at least one indented textured grip portion 25, and a closed base 30. The embodiment is not limited to various caps or lids that may be attached. The inner cavity has longitudinal corners 35 formed by the adjoined sides of the body.

### DESCRIPTION OF DRAWINGS

FIG. 1 illustrates a perspective view of an example embodiment with a body of four sides coupled with a neck

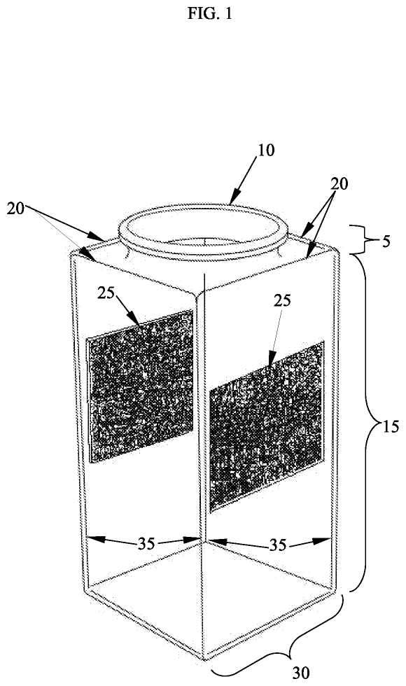

FIG. 2 illustrates a perspective view of an example embodiment with a body of four sides without a neck

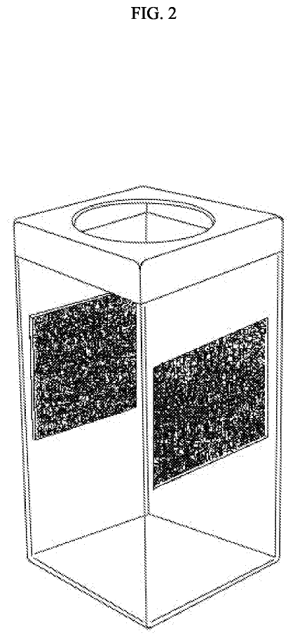

FIG. 3 illustrates a perspective view of an example embodiment with a body of three sides without a neck

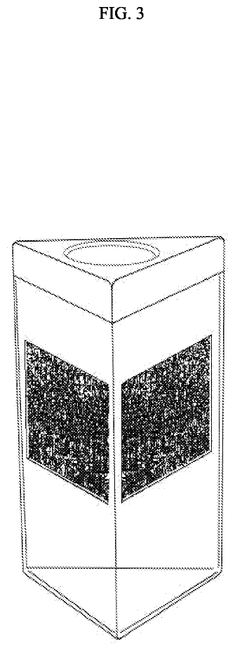

1. An apparatus for containment of medicinal elements comprising; a structural shape having a closed base bottom portion, body portion with at least three vertical flat sides, at least one indented textured grip portion, neck coupled to the body, with a top portion opening.
